(19) United States
(12) Patent Application Publication
(10) Pub. No.: US 2014/0122594 A1
(43) Pub. Date: May 1, 2014

(54) METHOD AND APPARATUS FOR DETERMINING USER SATISFACTION WITH SERVICES PROVIDED IN A COMMUNICATION NETWORK

(71) Applicant: Alcatel-Lucent USA Inc., Murray Hill, NJ (US)

(72) Inventors: Huseyin Uzunalioglu, Millington, NJ (US); Jeffrey J. Spiess, Denton, TX (US); Dan Kushnir, Springfield, NJ (US)

(73) Assignee: Alcatel-Lucent USA, Inc., Murray Hill, NJ (US)

(21) Appl. No.: 13/853,760

(22) Filed: Mar. 29, 2013

Related U.S. Application Data
(60) Provisional application No. 61/667,636, filed on Jul. 3, 2012.

(51) Int. Cl. H04L 29/08

(52) U.S. Cl. CPC H04L 67/22
USPC 709/204

(57) ABSTRACT

A processing platform comprises at least one processing device having a processor coupled to a memory. The processing platform is configured to identify particular metrics that influence user satisfaction with communication services provided by a communication network, and to generate at least one model that relates the identified metrics to user satisfaction scores. The processing platform may be further configured to generate at least one user satisfaction score for a plurality of users of the communication services given specified values of the identified metrics for only a subset of those users. For example, separate user satisfaction scores may be generated for respective ones of the users. Additionally or alternatively, a single per-segment user satisfaction score may be generated for each of one or more segments of multiple users.

### PRIORITY CLAIM

Priority is claimed to U.S. Provisional Application Ser. No. 61/667,636, filed Jul. 3, 2012 and entitled “Method and Apparatus for Determining User Satisfaction with Services Provided in a Communication Network,” which is incorporated by reference herein.

### FIELD

The present invention relates generally to communication networks, and more particularly to techniques for determining user satisfaction with mobile data services or other types of services provided in such networks.

### BACKGROUND

As the number of subscribers for mobile data services in certain communication networks is reaching a saturation point, operators of these networks have started to focus on improving subscriber experience in order to retain their existing subscribers and acquire new ones.

Thus, understanding whether a given subscriber or other customer, more generally referred to herein as a “user,” is happy and satisfied with the provided communication services is of utmost importance.

Today subscriber satisfaction with communication network services is often measured by surveying a small sample of all subscribers. Such surveying generally involves asking questions about satisfaction of the subscribers with the provided services.

Another conventional approach to measuring subscriber satisfaction with communication services is to perform controlled experiments where a small number of subjects perform communication tasks on their respective devices while the quality of the communication is degraded without the knowledge of the subjects. Following the experiment, the subjects are asked to respond to survey questions. Although useful, this approach has a number of limitations. First, controlled experiments of this type often do not adequately represent real-life situations where the subscriber experience is impacted. Secondly, these experiments are usually performed separately for different communication services, e.g., web browsing, video streaming and messaging. In reality, each subscriber may utilize each of these services in different proportions and the satisfaction is a function of experience throughout the usage of all of them.

### SUMMARY

Embodiments of the invention provide improved techniques for determining user satisfaction with services provided in a communication network. These techniques can overcome disadvantages associated with one or more of the conventional arrangements described above.

In one embodiment, a processing platform comprises at least one processing device having a processor coupled to a memory. The processing platform is configured to identify particular metrics that influence user satisfaction with communication services provided by a communication network, and to generate at least one model that relates the identified metrics to user satisfaction scores. The processing platform may be further configured to generate at least one user satisfaction score for a plurality of users of the communication services given specified values of the identified metrics for only a subset of those users. For example, separate user satisfaction scores may be generated for respective ones of the users. Additionally or alternatively, a single per-segment user satisfaction score may be generated for each of one or more segments of multiple users.

The processing platform in some embodiments may further comprise a statistical analysis and machine learning platform that operates in one or more distinct layers. For example, in an arrangement in which the statistical analysis and machine learning platform comprises at least two layers, a first one of the layers may be configured to apply machine learning algorithms to identify key quality of experience metrics on a per-application basis and to generate a first model that relates the per-application key quality of experience metrics to respective application satisfaction scores, and a second one of the layers may be configured to process the first model and overall user satisfaction metrics to generate a second model that produces user satisfaction scores on a per-user basis. Numerous other platform and layer configurations may be used in other embodiments.

### BRIEF DESCRIPTION OF THE DRAWINGS

FIG. 1 shows a communication network coupled to a user satisfaction processing platform in an illustrative embodiment of the invention.

FIGS. 2 and 3 show examples of process flows in the user satisfaction processing platform of FIG. 1.

FIG. 4 shows one example of a set of networked processing devices that may be used to implement at least a portion of the user satisfaction processing platform of FIG. 1.

### DETAILED DESCRIPTION

Illustrative embodiments of the invention will be described herein with reference to exemplary communication networks, processing platforms, processing devices and associated processes for determining user satisfaction with communication services. It should be understood, however, that the invention is not limited to use with the particular networks, platforms, devices and processes described, but is instead more generally applicable to any communication network application in which it is desirable to provide more accurate characterization of user satisfaction with mobile data services or other types of communication services.

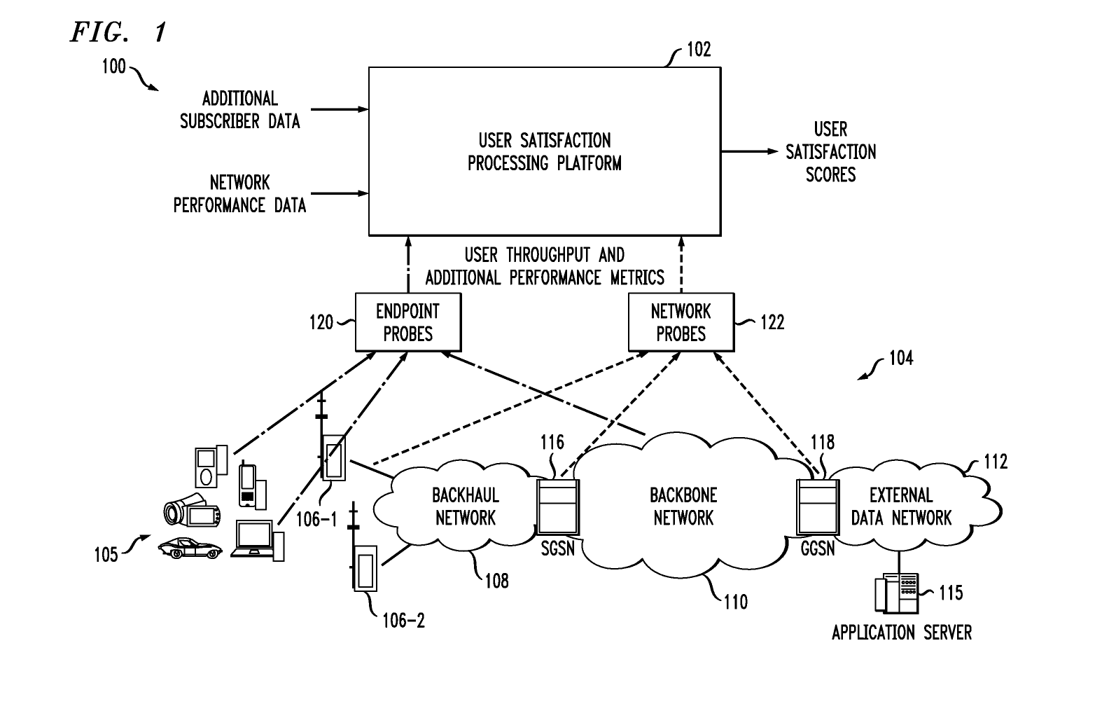

FIG. 1 shows a communication system 100 comprising a user satisfaction processing platform 102 coupled to a communication network 104. As will be described in more detail below, the user satisfaction processing platform 102 is configured to identify particular metrics that influence user satisfaction with communication services provided by the communication network 104, and to generate at least one model that relates the identified metrics to user satisfaction scores.

By way of example, the model may comprise a predictive model that is utilized to generate at least one user satisfaction score for a plurality of users of the communication services given specified values of the identified metrics for only a subset of those users. This may involve generating separate user satisfaction scores for respective ones of the users. Additionally or alternatively, a single per-segment user satisfaction score may be generated for each of one or more segments of multiple users. Thus, embodiments of the invention may provide user satisfaction scores for each user individually as well as a per-segment user satisfaction score for a particular group or other segment of users.

It should be noted that the term “users” as utilized herein is intended to be broadly construed, and may encompass, for example, subscribers or other customers of the communication network 104. For example, users may be subscribers to particular data services provided by the communication network, such as mobile data services. As another example, users may be respective businesses, organizations or other enterprises that utilize one or more services of the communication network 104. References herein to satisfaction scores associated with subscribers, customers or enterprises should therefore be understood as examples of what are more generally referred to as “user satisfaction scores.”

In the present embodiment, the communication network 104 comprises a plurality of user devices 105, such as computers and mobile telephones, configured to communicate with base stations 106-1 and 106-2. The base stations 106 are coupled to a backhaul network 108. The backhaul network 108 is coupled via backbone network 110 to an external data network 112. An application server 115 is associated with the external data network 112. The backhaul network 108 is coupled to the backbone network 110 via a Serving GPRS Support Node (SGSN) 116, and the backbone network 110 is coupled to the external data network 112 via a Gateway GPRS Support Node (GGSN) 118, where GPRS denotes General Packet Radio Service.

It is to be appreciated that the particular arrangement of communication network 104 shown in FIG. 1 is presented by way of illustrative example only. The communication network 104 may more generally comprise any type of communication network suitable for transporting data or other signals, and embodiments of the invention are not limited in this regard. For example, portions of the communication network 104 may comprise a wide area network (WAN) such as the Internet, a metropolitan area network, a local area network (LAN), a cable network, a telephone network, a satellite network, as well as portions or combinations of these or other networks. The term “network” as used herein is therefore intended to be broadly construed. A given network may comprise, for example, routers, switches, servers, computers, terminals, nodes or other processing devices, in any combination.

The user satisfaction processing platform 102 in the present embodiment receives user throughput and additional performance metrics via endpoint probes 120 and network probes 122, and possibly through additional channels not explicitly shown. The user satisfaction processing platform 102 utilizes this information as well as additional subscriber data and network performance data to generate one or more user satisfaction models that can be used to generate user satisfaction scores relating to mobile data services or other communication services provided by the communication network 104.

As will be described, the user satisfaction processing platform 102 allows user satisfaction to be linked to measurable quantities of performance metrics in the communication network 104, such that the network operator can monitor and optimize these metrics. Accordingly, the processing platform can identify the particular network metrics that lead to user satisfaction, providing operators with an understanding of those metrics that should be optimized in order to increase user satisfaction. It can also identify the degree to which the particular network metrics influence user satisfaction.

For example, the processing platform 102 in a given embodiment can identify linkages between user satisfaction and mobile data Quality of Experience (QoE) metrics, which may include network Key Performance Indicators (KPIs) and service Key Quality Indicators (KQIs). KPIs and KQIs can be directly measured from the communication network 104, possibly using probes 120 and 122, or other communication channels. Also, such KPIs and KQIs may be used as inputs in a combinatorial formula that computes a QoE score per user, and perhaps per service or application. A given network operator may collect a large number of KPIs and KQIs, and embodiments of the present invention allow the operator to utilize these metrics, for example, to predict how satisfied a given subscriber is with a mobile data service. A given such mobile data service may encompass web browsing, video streaming, messaging, bulk data transfer, and many others with each governed by different QoE metrics.

The processing platform 102 may be configured to apply data mining techniques to quantify the relationship between the QoE metrics and user satisfaction. In such an arrangement, the outputs of the processing platform 102 may include, for example, a list of important metrics impacting user satisfaction, and a mathematical model linking the important metrics to a user satisfaction score.

In one embodiment of this type, the processing platform 102 utilizes two layers of machine learning models. Input data to the first layer may include, for example, application QoE metrics per user, user satisfaction metrics per application per user, user-level performance metrics, additional network performance data, and additional user data (performance, usage, billing, CRM, etc.).

Machine learning algorithms such as regression and classification are applied to such input data to identify key QoE metrics for each application and to create a model that computes application satisfaction scores for each application and user given the input metrics other than the user satisfaction metrics.

This output is used as input to the second layer of machine learning algorithms. Additional input to this layer includes metrics for overall satisfaction with the communication services. The output of this stage of algorithms may include a list of important metrics for overall satisfaction and a model to compute subscriber satisfaction metrics given the input parameters as described above other than the user satisfaction metrics.

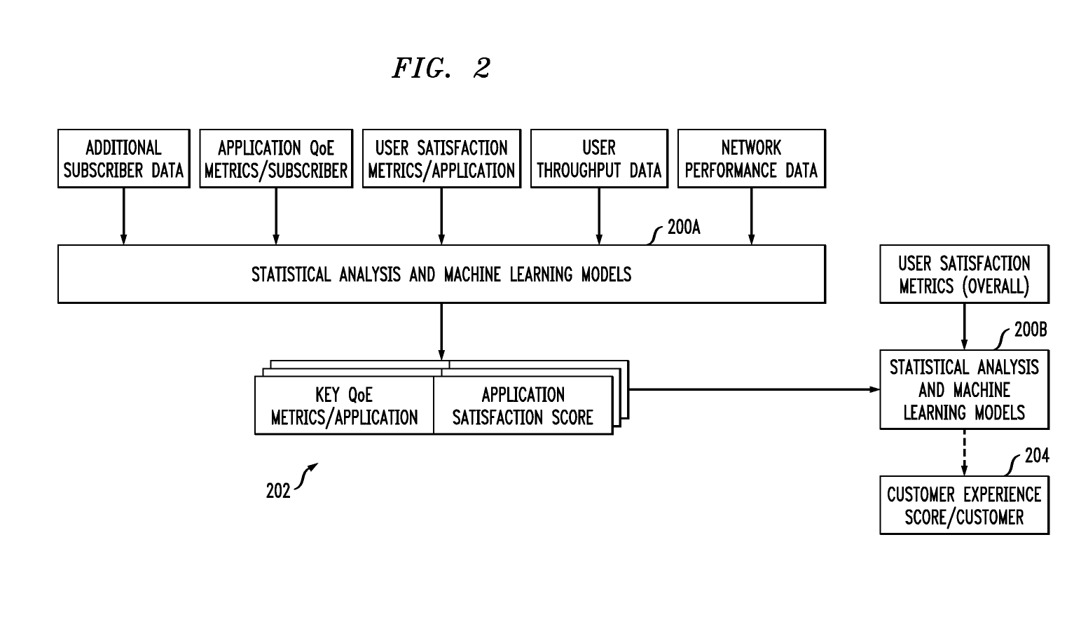

An example of the two-layer processing embodiment described above is illustrated in FIG. 2. In this embodiment, first and second layers of statistical analysis and machine learning models are denoted by respective reference numerals 200A and 200B. These first and second layers 200A and 200B may be viewed as comprising a type of statistical analysis and machine learning platform.

The first layer 200A receives application QoE metrics per subscriber, user satisfaction metrics per application, user throughput data, network performance data and additional subscriber data, and generates sets of outputs 202 with each such set comprising key QoE metrics per application and associated application satisfaction scores. These sets of outputs 202 are provided to the second layer 200B. The second layer 200B utilizes the sets of outputs 202 from the first layer 200A and overall user satisfaction metrics to generate a customer experience score per customer.

In other embodiments, the processing platform 102 may utilize only a single layer of machine learning models. An example of a single-layer processing embodiment is shown in FIG. 3. In this embodiment, a statistical analysis and machine learning platform 300 receives user throughput metrics, network performance metrics, subscriber/segment metrics, churn information and subscriber satisfaction survey results, and generates as its output a customer satisfaction model.

A given customer satisfaction model in one or more embodiments described herein can be used to answer questions such as:

1. How does data performance and usage impact satisfaction?

2. How do cell site metrics impact satisfaction?

3. What throughput level is needed for satisfaction?

These are only examples, and other types of customer satisfaction models may be generated in other embodiments.

In one or more of these embodiments, direct measurements of customer satisfaction for a sample of customers are utilized to build a predictive model that can calculate an estimated customer satisfaction score for all customers.

In a given embodiment, relationships between the QoE metrics and customer satisfaction are quantified in a real-life setting rather than in the confines of controlled experiments or reliance on domain knowledge. Also, a given model generated by the processing platform 102 may be configured to reflect the satisfaction with overall service rather than the individual components of a service. Such a model can be applied to compute satisfaction scores for individual subscribers in network operations settings. Thus, an operator can identify unsatisfied subscribers quickly and take proactive action to address the problem.

Moreover, quantification of the relationship between the QoE metrics and customer satisfaction and the understanding of the main service experience drivers allows operators to strategically target KPI/KQI improvements which provide greatest benefit in customer satisfaction that leads to:

1. Increased customer satisfaction and thus, increased service acceptance and reduced customer churn.

2. Fine tuning of network capacity, which would help to optimize capital expense spending to maximize customer experience.

3. Detection and prioritization of service-impacting degradations and outages which provides operating expense optimization through reduced calls to customer care lines.

It should be noted that, although particularly useful for predicting customer satisfaction with mobile data services, the disclosed techniques can be applied to any other types of communication services and any types of target metrics that influence customer satisfaction with those services.

Embodiments of the invention can therefore provide a holistic approach to determining customer satisfaction with mobile data services and other services. More particularly, the user satisfaction processing platform 102 can be configured to tie together information from a variety of applications with subjective subscriber perception and expectations, based on a varying degree of availability of quality metrics. The applications may include, for example, web browsing, video streaming, messaging, bulk data transfer, and many others with each governed by different QoE metrics. Each subscriber's quality perception and expectation is different and depends on performance of individual application used, application content, subscriber personalities, and variation in performance What is measured in the network depends on the availability of probes and monitoring systems as well as laws related to data collection at the subscriber-level.

The user satisfaction processing platform 102 in some embodiments is therefore configured to perform measurements at the application layer. This reflects the customer experience more directly compared to network-level measurements, and ensures that the metrics are aligned with the specific application.

A wide variety of different types of knowledge about the customers should be incorporated into the processing operations performed by the platform 102. This may involve, for example, computing a unique score for each customer utilizing all aspects of the customer's usage of the mobile data service or other service, in a manner that reflects the user or segment characteristics without violating privacy rules.

As indicated above, the user satisfaction processing platform 102 should be adaptive to data availability. This ensures that the platform can work effectively even when data availability at application level and subscriber level is limited. Also, the platform can extend easily when new data sources become available.

The user satisfaction processing platform 102 may be configured to learn continuously from the data. This allows the platform to adapt to changing mobile data service usage behaviors, and to identify the most influential metrics for customer experience from the available data.

The user satisfaction metrics are configured such that, given the application QoE metrics, the platform 102 can determine how happy a given customer is with his or her experience.

The user satisfaction metrics may be generated at least in part based on primary market research and associated surveys. Thus, for example, survey questions may be asked directly to the subscriber and the results correlated with the QoE metrics, either through traditional surveys and/or an app running on a mobile phone or other similar device. This helps in understanding what metrics are the most important per application and also for the overall service. The surveys and the associated correlation study should be done at the subscriber-level and should cover a large number of subscribers and applications. Also, the correlation study should be repeated periodically to handle changes in QoE-to-CX score mapping, where CX denotes customer experience. A CX score is one example of what is more generally referred to herein as a “user satisfaction score.”

The platform 102 may also be configured to identify and use surrogate metrics for subscriber satisfaction. Surrogate metrics for individual applications can be identified. For example, the length of video viewing session can be a surrogate metric for a video application. Similarly, the length of a web browsing session can be a surrogate metric for a web browsing application. Surrogate metrics for an overall service can be identified such as subscriber referrals, churn events, up-sell and cross-sell success, etc. Also, statistical and machine-learning techniques can be applied to automate QoE-to-CX score mapping.

A given customer experience score can be computed using model building and scoring phases. The key goals of the model building phase are to identify the most important metrics to predict subscriber satisfaction with the mobile data service or other service, to create a model or a formula to combine these important metrics to generate a satisfaction score, and to identify target objectives to maximize positive subscriber experience at minimal network cost. An example of identification of a target objective would be determining a page response objective that the network should be configured to support. The key goals of the scoring phase are to compute the mobile data experience scores for each subscriber given the values of the important metrics over a certain time period, such as a month, for each subscriber, to provide main drivers for the experience score at the individual subscriber level, and to perform customer segmentation.

A user satisfaction processing platform may be built using a phased approach. For example, multiple phases may be used to configure and deploy a user satisfaction processing platform. It is to be appreciated that numerous other arrangements may be used in configuring and deploying such a platform in other embodiments. As one more particular example of a phased configuration and deployment, three phases may be used, including a first phase in which one or more models, such as a customer satisfaction model and possibly a churn model, are determined using initial required metrics, a second phase in which application-level metrics are added, and a third phase in which the platform is enhanced using surrogate metrics for customer satisfaction. Numerous other types of multiple phase configuration and deployments may be used in implementing a user satisfaction processing platform 102.

The above-noted churn model may be configured to permit determination of the manner in which data performance and usage impact churn, and the manner in which cell site metrics impact churn.

Examples of types of QoE data utilized in the first phase of the exemplary three-phase configuration and deployment process described above include:

1. User throughput data such as uplink/downlink data throughput and associated throughput variance per subscriber.

2. Network traffic and performance data, including statistics describing PDP context failure rate and 3G attach success rate; cell site metrics such as average user throughput and number of attached mobiles, and packet delay and packet loss.

3. Subscriber data such as CDRs, XDRs with location and usage information, billing information such as total revenues and recurring charges, contract length, handset type, OS and price, and date of change/upgrade.

4. Churn data, such as a churn data set of 100K users (e.g., half churners).

5. Demographic and geographical information such as site info, location, etc.

6. Existing subscriber satisfaction survey results per subscriber.

It should be noted that performance statistics may be provided in a number of granularities, i.e., mean, median, max, per busy hour, per month, etc. Also, as indicated previously, certain data may need to be anonymized to meet privacy protection rules and other laws.

In adding application-level metrics in the second phase of the exemplary three-phase process, an application satisfaction model may be generated that allows the platform to determine, for example, what throughput level is needed for satisfaction with an application, and how sufficient is the throughput measurement as an application satisfaction metric. Also, the above-noted customer satisfaction model may be updated to indicate how application usage impacts satisfaction, and the above-noted churn model may be updated to indicate how application usage impacts churn.

Application performance metrics added in the second phase may include aggregate usage metrics at the application level, such as web browsing, video download and streaming video. More particular examples include page response time, object download time, page size (e.g., bytes), number of objects in page, session length (e.g., duration of browsing activity), number of pages visited per browsing session, average stream bandwidth and variance, video height & width, switch up/down count, video completion rate, initial buffering delay, re-buffering (e.g., frequency and total duration), content type (e.g., short-form, long-form, live event), length of viewing session, and number of videos viewed per session. Again, performance statistics may be provided in a number of granularities, i.e., mean, median, max, per busy hour, per month, etc.

The third phase of the exemplary three-phase process may involve quantifying the performance of the surrogate metrics to predict satisfaction, and building a final model with metrics of choice based on performance-cost-value tradeoffs.

Again, the particular multiple phase configuration and deployment process described above is presented by way of example only, and in other embodiments multiple phases need not be used.

In accordance with another aspect of the present invention, one or more embodiments can be configured to filter non-informative data from user satisfaction surveys. For example, many user satisfaction surveys may be answered in a non-informative way, thus making satisfaction prediction and model building more difficult and prone to faults. One manifestation of this phenomenon is a high overlap between satisfaction ratings given for bad service with those given for good service. Accordingly, a given embodiment of the present invention can be configured to detect the presence of user satisfaction surveys or portions thereof in which possible answers are numerical within a relatively wide range, and to filter out non-informative data from those surveys. Such non-informative data may comprise at least portions of each of the surveys in which identical answers were given to all of the questions in a given such portion. This filtering of non-informative data leads to better separation of the satisfaction ratings for good and bad service, resulting in more accurate customer satisfaction models.

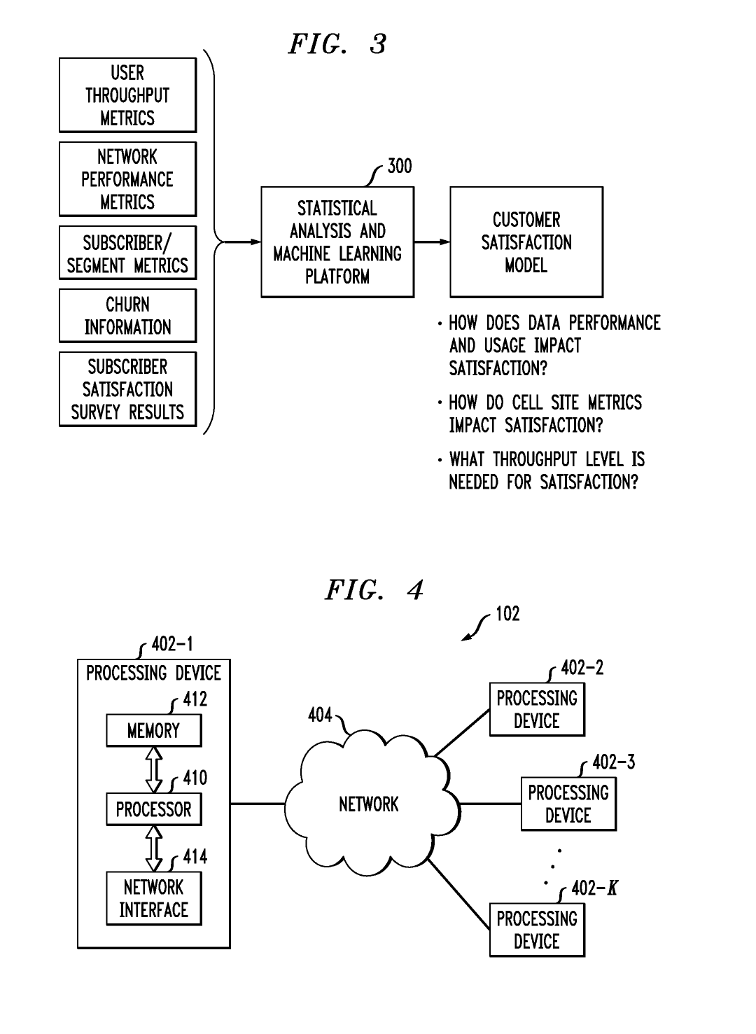

As indicated previously, the communication system 100 may be implemented at least in part using one or more processing platforms. One or more of the processing modules or other components of user satisfaction processing platform 102 or other portions of communication system 100 may therefore each run on a computer, server, storage device or other processing platform element. A given such element may be viewed as an example of what is more generally referred to herein as a “processing device.” An example of such a processing platform is processing platform 400 shown in FIG. 4.

The processing platform 400 in this embodiment comprises a portion of the communication system 100 and includes a plurality of processing devices, denoted 402-1, 402-2, 402-3, . . . 402-K, which communicate with one another over a network 404. The network 404 may comprise any type of network, such as a WAN, a LAN, a satellite network, a telephone or cable network, or various portions or combinations of these and other types of networks.

The processing device 402-1 in the processing platform 400 comprises a processor 410 coupled to a memory 412. The processor 410 may comprise a microprocessor, a microcontroller, an application-specific integrated circuit (ASIC), a field-programmable gate array (FPGA) or other type of processing circuitry, as well as portions or combinations of such circuitry elements, and the memory 412, which may be viewed as an example of a “computer-readable storage medium” having executable computer program code embodied therein, may comprise random access memory (RAM), read-only memory (ROM) or other types of memory, in any combination.

Also included in the processing device 402-1 is network interface circuitry 414, which is used to interface the processing device with the network 404 and other system components, and may comprise conventional transceivers.

The other processing devices 402 of the processing platform 400 are assumed to be configured in a manner similar to that shown for processing device 402-1 in the figure.

Again, the particular processing platform 400 shown in the figure is presented by way of example only, and communication system 100 may include additional or alternative processing platforms, as well as numerous distinct processing platforms in any combination, with each such platform comprising one or more computers, servers, storage devices or other processing devices.

Multiple elements of communication system 100 may be collectively implemented on a common processing platform of the type shown in FIG. 4, or each such element may be implemented on a separate processing platform.

As mentioned above, embodiments of the present invention may be implemented at least in part in the form of one or more software programs that are stored in a memory or other computer-readable storage medium of a network device or other processing device of a communication network or system.

Of course, numerous alternative arrangements of hardware, software or firmware in any combination may be utilized in implementing these and other system elements in accordance with the invention.

For example, embodiments of the present invention may be implemented in one or more ASICS, FPGAs or other types of integrated circuit devices, in any combination. Such integrated circuit devices, as well as portions or combinations thereof, are examples of “circuitry” as the latter term is used herein.

As another example, embodiments of the invention can be implemented using processing platforms that include cloud infrastructure or other types of virtual infrastructure. Such virtual infrastructure generally comprises one or more virtual machines and at least one associated hypervisor running on underlying physical infrastructure.

It should again be emphasized that the embodiments described above are for purposes of illustration only, and should not be interpreted as limiting in any way. Other embodiments may use different types of communication networks, processing platforms and devices, and processes for determining user satisfaction with communication services, depending on the needs of a particular implementation. Alternative embodiments may therefore utilize the techniques described herein in other contexts in which it is desirable to provide accurate and efficient determinations of user satisfaction with communication services. These and numerous other alternative embodiments within the scope of the appended claims will be readily apparent to those skilled in the art.

What is claimed is:

1. A method comprising the steps of:
identifying particular metrics that influence user satisfaction with communication services provided by a communication network; and
generating at least one model that relates the identified metrics to user satisfaction scores;
wherein the identifying and generating steps are performed at least in part by a processing platform comprising one or more processing devices.

2. The method of claim 1 wherein the model is utilized to generate at least one user satisfaction score for a plurality of users of the communication services given specified values of the identified metrics for only a subset of those users.

3. The method of claim 2 wherein the model is utilized to generate at least one of:
separate user satisfaction scores for respective ones of the users; and
a single per-segment user satisfaction score for each of one or more segments of multiple users.

4. The method of claim 2 wherein the users comprise at least one of customers and subscribers of the communication network and wherein the communication services comprise mobile data services.

5. The method of claim 1 wherein the identified metrics comprise a plurality of target metrics identified from among a set of available metrics that are measurable in the communication network.

6. The method of claim 5 wherein at least a portion of the available metrics are based on information collected from the communication network utilizing at least one of endpoint probes and network probes.

7. The method of claim 1 wherein the identifying and generating steps are performed at least in part by a statistical analysis and machine learning platform, wherein the statistical analysis and machine learning platform operates in one or more distinct layers.

8. The method of claim 7 wherein a first one of the layers applies machine learning algorithms to identify key quality of experience metrics on a per-application basis and generates a first model that relates the per-application key quality of experience metrics to respective application satisfaction scores.

9. The method of claim 8 wherein a second one of the layers processes the first model and overall user satisfaction metrics to generate a second model that produces user satisfaction scores on a per-user basis.

10. The method of claim 7 wherein the statistical analysis and machine learning platform operates in at least one layer in which input metrics are processed to identify the particular metrics and a user satisfaction model is generated that relates the identified metrics to user satisfaction scores.

11. The method of claim 5 wherein the set of available metrics comprises one or more of per-user application-level metrics, per-application user satisfaction metrics, overall user satisfaction metrics, user throughput metrics, network performance metrics and user/segment metrics.

12. The method of claim 7 wherein the statistical analysis and machine learning platform performs at least a portion of the identifying and generating steps at least in part utilizing additional information including at least one of churn information and satisfaction survey results.

13. The method of claim 12 wherein at least a portion of the satisfaction survey results are filtered to remove non-informative data.

14. The method of claim 1 wherein the model is generated at least in part based on direct measurements of user satisfaction for a sampling of a plurality of users and comprises a predictive model that is utilizable to calculate an estimated user satisfaction score for the plurality of users.

15. An article of manufacture comprising a computer-readable storage medium having embodied therein executable program code that when executed causes the processing platform to perform the steps of the method of claim 1.

16. An apparatus comprising:
a processing platform comprising at least one processing device having a processor coupled to a memory;
wherein the processing platform is configured to identify particular metrics that influence user satisfaction with communication services provided by a communication network, and to generate at least one model that relates the identified metrics to user satisfaction scores.

17. The apparatus of claim 16 wherein the processing platform is further configured to generate at least one user satisfaction score for a plurality of users of the communication services given specified values of the identified metrics for those users.

18. The apparatus of claim 16 wherein the identified metrics comprise a plurality of target metrics identified from among a set of available metrics that are measurable in the communication network.

19. The apparatus of claim 18 wherein the processing platform is further configured to obtain at least a portion of the available metrics based on information collected from the communication network utilizing at least one of endpoint probes and network probes.

20. The apparatus of claim 16 wherein the processing platform further comprises a statistical analysis and machine learning platform, wherein the statistical analysis and machine learning platform operates in at least two distinct layers, with a first one of the layers applying machine learning algorithms to identify key quality of experience metrics on a per-application basis and generating a first model that relates the per-application key quality of experience metrics to respective application satisfaction scores, and a second one of the layers processing the first model and overall user satisfaction metrics to generate a second model that produces user satisfaction scores on a per-user basis.
